(19) United States
(12) Patent Application Publication
(10) Pub. No.: US 2024/0070223 A1
(43) Pub. Date: Feb. 29, 2024

(54) INCREASED COMPUTATION EFFICIENCY WITH MULTI-STAGE 8-BIT FLOATING POINT MATRIX MULTIPLICATION WITH FORMAT CONVERSION

(71) Applicant: Microsoft Technology Licensing, LLC, Redmond, WA (US)

(72) Inventors: Yu YAN, Bellevue, WA (US); Timothy Lawrence HARRIS, Cambridge (GB)

(21) Appl. No.: 18/064,223

(22) Filed: Dec. 9, 2022

Related U.S. Application Data
(60) Provisional application No. 63/374,125, filed on Aug. 31, 2022.

(51) Int. Cl. G06F 17/16; G06F 7/483

(52) U.S. Cl. CPC G06F 17/16; G06F 7/483

(57) ABSTRACT

Example solutions for multi-stage 8-bit floating point (FP8) matrix multiplication with format conversion, that benefit computation efficiency of matrix multiplication operations by a processor, include: copying data values in FP8 format from global memory to shared memory; loading thread block tiles of FP8 data values from the shared memory into a set of registers; converting each of the multiple FP8 data values in the set of registers to 16-bit floating point (FP16) data values; submitting the FP16 data values to the tensor core; and performing, with the tensor core, matrix multiply accumulate computations.

### CROSS REFERENCE TO RELATED APPLICATION

This application claims the benefit of U.S. Provisional Patent Application Ser. No. 63/374,125 filed on Aug. 31, 2022 and entitled “Multi-Stage 8-Bit Floating Point Matrix Multiplication with Format Conversion”, which is hereby incorporated by reference in its entirety for all intents and purposes.

### BACKGROUND

Matrix multiplication is used in a wide variety of computational tasks, for example, image, text, and software code generation, in conjunction with machine learning (ML) models, such as neural networks (NNs). Graphics processing units (GPUs) with tensor cores are examples of hardware that excel at performing matrix multiplication quickly.

However, hardware-optimized solutions are configured for particular data types (e.g., data formats) with the data values in a particular layout to maximize throughput. If data is submitted to a hardware-optimized solution in a different layout and/or a different format, the processing is delayed while the format is converted and/or the layout is shifted to an accepted layout. This situation may arise with some degree of regularity, when storage limitations for large matrices or latency limitations drive developers to use a data format with fewer bit fields than the data type accepted by a hardware-optimized matrix multiplication solution, or upstream software writes data in a different layout.

### SUMMARY

The disclosed examples are described in detail below with reference to the accompanying drawing figures listed below. The following summary is provided to illustrate some examples disclosed herein. It following, in the sequence, a reference frame of a reference frame set is not meant, however, to limit all examples to any particular configuration or sequence of operations.

Example solutions for multi-stage 8-bit floating point (FP8) matrix multiplication with format conversion, that benefit computation efficiency of matrix multiplication operations by a processor, include: copying data values in FP8 format from global memory to shared memory; loading thread block tiles of FP8 data values from the shared memory into a set of registers; converting each of the multiple FP8 data values in the set of registers to 16-bit floating point (FP16) data values; submitting the FP16 data values to the tensor core; and performing, with the tensor core, matrix multiply accumulate (MMA) computations.

### BRIEF DESCRIPTION OF THE DRAWINGS

The disclosed examples are described in detail below with reference to the accompanying drawing figures listed below:

FIG. 1 illustrates an example architecture that provides for multi-stage 8-bit floating point (FP8) matrix multiplication with format conversion, and benefits computation efficiency of matrix multiplication operations by a processor;

FIG. 2 provides an example graphical representation of matrix multiplication, including some matrix multiply accumulate (MMA) parameters used by example architectures, such as the example architecture in FIG. 1;

FIG. 3 illustrates example bit fields of 8-bit floating point (FP8) and 16-bit floating point (FP16) numbers, and an example conversion scheme used by example architectures, such as the example architecture in FIG. 1;

FIG. 4 illustrates an example workflow view of FP8 to FP16 conversion and MMA calculations performed by example architectures, such as the example architecture in FIG. 1;

FIG. 5 illustrates another example workflow view of MMA calculations performed by example architectures, such as the example architecture in FIG. 1;

FIG. 6 illustrates additional detail for the workflow view of FIG. 5;

FIG. 7 illustrates an example timeline of events that occur when using example architectures, such as the example architecture in FIG. 1;

FIG. 8 illustrates example data flows that occur concurrently when using example architectures, such as the example architecture in FIG. 1;

FIG. 9 illustrates an example pipeline, implemented by example architectures, such as the example architecture in FIG. 1, that performs various events concurrently;

FIG. 10 provides an example graphical representation of copying data values, from global memory to shared memory, as occurs when using example architectures, such as the example architecture in FIG. 1;

FIG. 11 provides an example graphical representation of loading data values, from shared memory into registers, as occurs when using example architectures, such as the example architecture in FIG. 1;

FIG. 12 provides an example graphical representation of converting data values in the registers of FIG. 11, from FP8 to FP16, as occurs when using example architectures, such as the example architecture in FIG. 1;

FIG. 13 shows a flowchart illustrating exemplary operations that may be performed when using example architectures, such as the example architecture in FIG. 1;

FIG. 14 shows another flowchart illustrating exemplary operations that may be performed when using example architectures, such as the example architecture in FIG. 1; and

FIG. 15 shows a block diagram of an example computing device suitable for implementing some of the various examples disclosed herein.

Corresponding reference characters indicate corresponding parts throughout the drawings. Any of the drawings may be combined into a single embodiment.

### DETAILED DESCRIPTION

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

Example solutions for multi-stage 8-bit floating point (FP8) matrix multiplication with format conversion, that benefit computation efficiency of matrix multiplication operations by a processor, include: copying data values in FP8 format from global memory to shared memory; loading thread block tiles of FP8 data values from the shared memory into a set of registers; converting each of the multiple FP8 data values in the set of registers to 16-bit floating point (FP16) format data values; submitting the FP16 data values to the tensor core; and performing, with the tensor core, matrix multiply accumulate (MMA) computations.

Aspects of the disclosure benefit the operations of computing devices, for example, by increasing the speed of matrix multiplications, reducing the memory required, and reducing electrical consumption. The speed of matrix multiplications is increased at least by converting each of multiple FP8 data values in the set of registers to FP16 data values. Performing the conversion in registers prior to submission to the tensor core increases speed, compared with conversion before storing data values to shared memory. Memory capacity and bandwidth reduction is achieved by enabling the use of FP8 data values in global memory and shared memory, shifting the traditional memory/speed trade-off, and reducing the size of any neural network (NN) or other machine learning (ML) component that is using the MMA computations. Electrical power consumption is reduced at least by the use of less memory and fewer processing cycles.

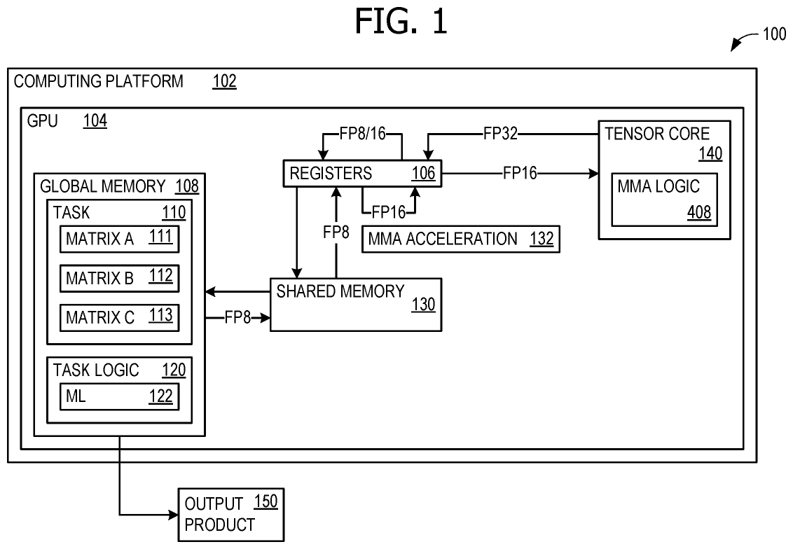

FIG. 1 illustrates an example architecture 100 that provides for multi-stage FP8 matrix multiplication with format conversion, and benefits computation efficiency of matrix multiplication operations by a processor. A computing platform 102 performs matrix multiplication, C=A×B. in order to produce an output product 150, including a recommendation such as a generated image, generated text, generated software code, or another output product that relies upon matrix multiplication. In some examples, several matrix multiplications and other operations are required between the multiplication produce an output. In architecture 100, the matrix multiplication is implemented as MMA in a tensor core 140 within a graphics processing unit (GPU) 104.

In general, GPUs are able to process multiple pieces of data simultaneously, rendering them useful for ML, video editing, and gaming applications. Multiple different types of memories are used with GPUs, including global memory, shared memory, and registers. These may be referred to, respectively, as a first memory, a second memory, and a third memory. Global memory tends to be the slowest, but is also typically the largest storage space. Shared memory is often faster than global memory, but more limited in size. Registers are faster still, although typically tightly limited in capacity.

Tensor core 140 expects FP16 data values in a particular layout. However, of the matrices to be multiplied, matrix A 111 and matrix B 112, at least one has stored FP8 data values, in order to save memory space. In some examples, matrix A 111 is in FP16 format and matrix B 112 is in FP8 format. Format conversion is required when tensor core does not support FP8 matrix multiplication natively or these two matrices have different data formats.

To increase the speed of the matrix multiplication, an MMA acceleration 132 performs FP8 to FP16 format conversion within a set of registers 106 and arranges the layout of the data values pulled from matrix A 111 and matrix B 112 into the layout expected by tensor core 140. Performing the format conversion in set of registers 106, and rearranging the layout and submitting data values from matrix A 111 and matrix B 112 in the order expected by MMA (e.g., as warp tiles) permits the MMA process in tensor core 140 to execute without bottlenecks. This significantly increased the speed of the matrix multiplication stage of producing output product 150.

Matrix multiplication is the major operation type when running ML models in GPUs or other hardware accelerators. Transformer-based workloads that generate text or software code operate using a technique known as auto-regressive generation. During generation, one new token is produced in each model forward step. A model forward step has multiple matrix multiplication operations that individually may have low computing intensity in the token-by-token generation stage. A primary speed bottleneck for these operations is loading model weights from global memory 108 to shared memory 130 or set of registers 106.

GPU 104 produces output product 150 by executing a task 110 using task logic 120 (e.g., a software program that performs task 110 to produce output product 150). Task logic 120 contains an ML model 122, which may include an NN. Performing task 110 requires multiplying matrix A 111 and matrix B 112 to compute a matrix C 113. Task logic 120 and data for task 110 are stored in a global memory 108, which may comprise high bandwidth memory (HBM), such as second generation high bandwidth memory (HBM2) or third generation high bandwidth memory (HBM3). In some examples, global memory 108 is not located within the same integrated circuit (IC) package as tensor core 140.

To save space in global memory 108, matrix A 111 or matrix B 112, or both, is in FP8 format. Because FP8 format requires only 8 bits, whereas FP16 format requires 16 bits, and other floating point formats require 32 or 64 bits, the use of FP8 may be preferable when the required numerical precision and range of values permits. Storing data in the lower precision (e.g., FP8 format) also saves data loading cost between global memory 108 and shared memory 130. Unfortunately, some GPUs do not support FP8 in MMA. Converting data values from FP8 to FP16 format prior to storage in shared memory 130 may prevents the use of some optimized asynchronous copy operations provided by common GPUs, and may also limit data loading parallelism. In some examples, shared memory 130 is located within the same IC package as tensor core 140, and is a faster memory type than global memory 108.

FIG. 1 illustrates both matrix A 111 or matrix B 112 in global memory 108, although in some examples, only a single one of matrix A 111 and matrix B 112 is in global memory 108. For example, matrix B 112 may be held in FP8 in global memory, while matrix A 112 may be generated by a previous computation, and held in shared memory 103.

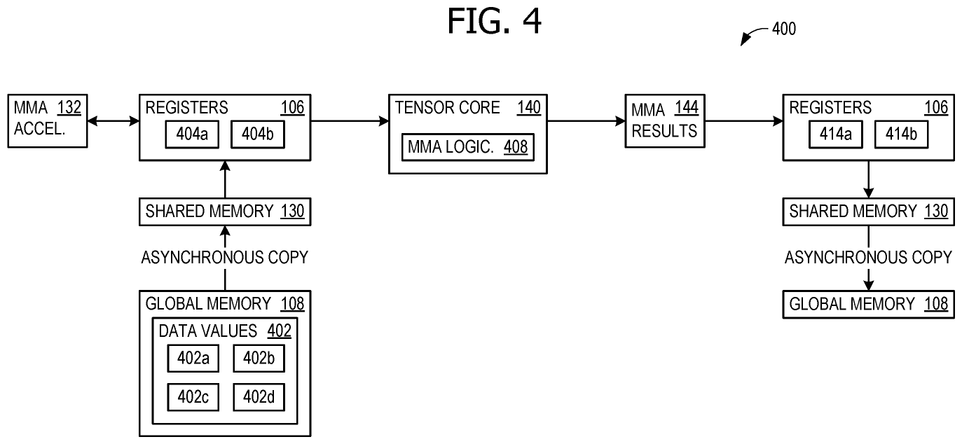

Data values (e.g., data values 402a-402d of FIG. 4) of matrix A 111 and/or matrix B 112 are copied from global memory 108 to a shared memory 130 and loaded into set of registers 106, still in their original format. MMA acceleration 132 manages FP8 to FP16 format conversion while the data values are still within set of registers 106 and also arranges the layout of the data values according to the layout expected by tensor core 140. The data values are then supplied to tensor core 140 already in FP16 format, and in the proper layout. In some examples, GPU 104 has a plurality of tensor cores 140. In some examples, set of registers 106 is located within the same IC package as tensor core 140, and is a faster memory type than shared memory 130.

Tensor core 140 performs MMA on the submitted data values to compute MMA results 144. In some examples, MMA results 144 are in FP32, and tensor core 140 performs accumulation in FP32 as part of the MMA process. MMA results 144 are returned to set of registers 106 (or a different set of registers, in some examples) and optionally converted back to FP16 or FP8 format. MMA results 144 are then copied back to shared memory 130 and then copied back to global memory 108 as data values for matrix C 113.

In some examples, moving data values between global memory 108 and shared memory 130 uses an asynchronous copy operation. Asynchronous copying (async copy) transfers data between memory locations under the control of hardware enabling software on the GPU to proceed concurrently with other work while the copy completes. Use of asynchronous copy operations permits further a speed increase by aspects of the disclosure. The use of FP8 versus FP16 further speeds copy time between global memory 108 and shared memory 130, because fewer bits are transferred.

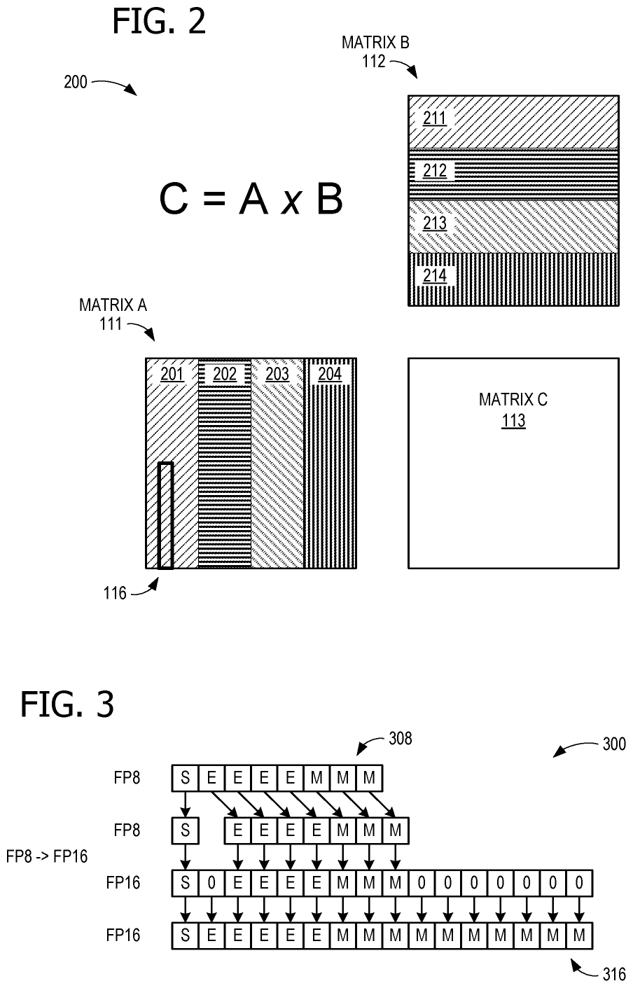

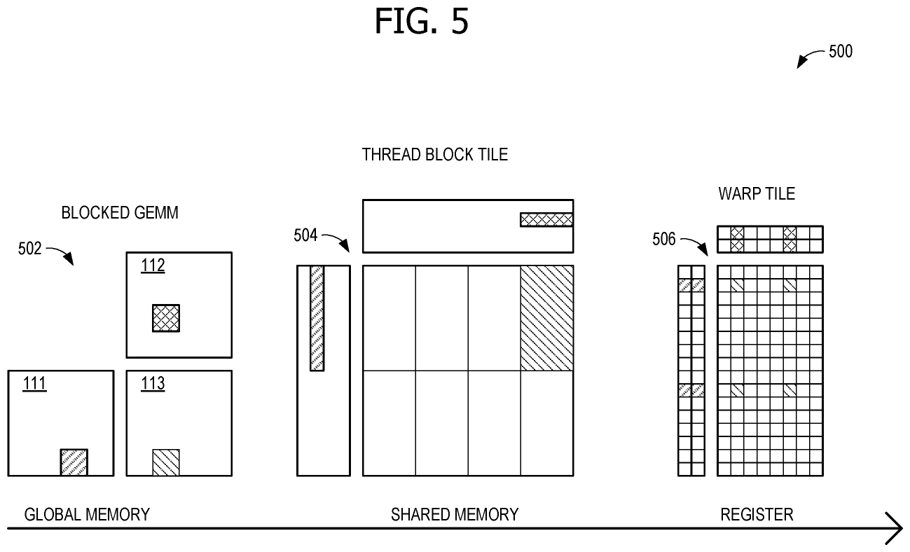

FIG. 2 provides a graphical representation 200 of matrix multiplication, including some MMA parameters used by architecture 100. The matrix multiplication depicted solves C=A×B, where C will become matrix C 113 and A and B represent data values pulled from matrix A 111 and matrix B 112, respectively. Matrix A 111 is shown as having a plurality of thread block tiles, specifically thread block tile 201, thread block tile 202, thread block tile 203, and thread block tile 204. Matrix B 112 is also shown as having a plurality of thread block tiles, specifically thread block tile 211, thread block tile 212, thread block tile 213, and thread block tile 214. The relative orientations of the thread block tiles (predominantly vertical for matrix A 111 and predominantly horizontal for matrix B 112) reflect the indexing progression of the respective matrices in matrix multiplication operations. The thread block tiles in the illustrated example are 128 bytes wide, although this is configurable and other sizes may be used in some examples. A warp 116 is also shown for matrix A 111. Thread block tiles and warps are described below, starting with reference to FIG. 5.

FIG. 3 illustrates bit fields of FP8 and FP16 numbers, and a conversion scheme 300 used by architecture 100. An FP8 number 308 has a single sign bit, denoted as S, an exponent field with four exponent bits, denoted as Es, and a mantissa field with three mantissa bits, denoted as Ms. An FP16 number 316 has a single sign bit, an exponent field with five exponent bits, and a mantissa field with ten mantissa bits. The conversion pads the exponent field of FP16 number 316 with a leading zero followed by the four exponent bits of FP8 number 308. For the mantissa, the conversion copies the three mantissa bits of FP8 number 308 and then pads the remaining mantissa field of FP16 number 316 with seven zeros.

FIG. 4 illustrates a workflow 400 of FP8 to FP16 conversion and MMA calculations performed by architecture 100. Global memory 40 has a plurality of data values in FP8 format. A data value 402a, a data value 402b, a data value 402c, and a data value 402d are shown. These data values are copied from global memory 108 to shared memory 130. Some examples use asynchronous copy. From shared memory 130, the data values are loaded into set of registers 106. MMA acceleration 132 converts the data values from FP8 format to FP16 format, and permutes (shifts) them as necessary to be in the layout expected by tensor core 140. Data value 404a and data value 404b are in FP16, converted from data values 402a and 402c, respectively. Data values 402b and 404d are mapped to two additional numbers held in another register (not shown). It should be understood that larger numbers of data values are used in some examples.

Data values (e.g., data values 404a and 404b) are submitted to tensor core 140, and are held in set of registers 106 while MMA logic 408 performs an MMA process (e.g., MMA calculations) on them. This produces MMA results 144 inside set of registers 106 as FP32 data values. Tensor core 140 is able to read and write directly from/to set of registers 106. A data value 414a and a data value 414b are shown. In some examples, the data values in set of registers 106 are then converted to FP16 or FP8 format, and copied to shared memory 130 and then some may be copied to global memory 108. In some examples, asynchronous copy is used for the move to global memory 108.

FIG. 5 illustrates a workflow 500 of MMA calculations performed by architecture 100. Architecture 100 applies a tiling structure to implement general matrix multiply (GEMM) efficiently by decomposing the computation into a hierarchy of thread block tiles, warp tiles, and thread tiles and then accumulating matrix products. Stage 502 shows a blocked GEMM in global memory 108, with matrix A 111, matrix B 112, and matrix C 113 and a single thread block in each matrix is shown. In some examples, only one of matrix A 111 and matrix B 112 is in global memory 108, and the other is sufficiently small to be in shared memory 130. Similarly, depending on the size of the output, matrix C 113 may be sufficiently small to remain in shared memory 130.

Data movement from global memory 108 to shared memory 130 (matrix to thread block tile), from shared memory 130 to a register file (thread block tile to warp tile) in set of registers 106, and from the register file to tensor core 140 for computation (warp tile to thread tile) is illustrated.

Each thread block computes its part of the GEMM output by iteratively loading blocks of matrix data from the input matrices and computing an accumulated matrix product. The thread block tile structure is further partitioned into warps (groups of threads that execute together). Warps provide organization for the GEMM computation.

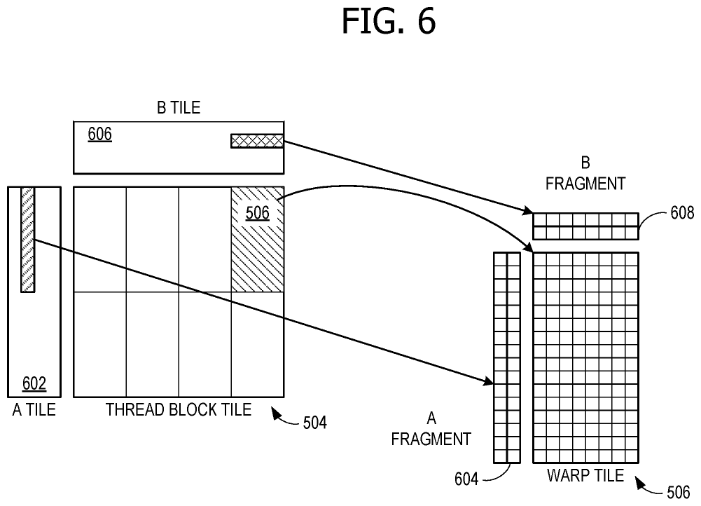

A thread block tile 504 is illustrated, along with the subsequent stage, a warp tile 506. Thread block tile 504 and warp tile 506 are described in further detail in relation to FIG. 6. The data values in warp tile 506 are distributed in each thread without duplication. The various threads collaborate to calculate the matrix multiplication in tensor core 140, which reduces the traffic for the registers.

FIG. 6 illustrates additional detail for workflow 500. Once data is stored in shared memory 130, each warp computes a sequence of accumulated matrix products by iterating over the dimension of the thread block tile, loading submatrices (or fragments) from shared memory, and computing an accumulated outer product. The sizes of the fragments are small, in some examples, to maximize the compute intensity relative to the amount of data loaded from shared memory. This prevents the bandwidth of shared memory 130 from becoming a bottleneck. An A tile 602 has a fragment 604, and a B tile 606 has a fragment 608 that correspond to warp tile 506. In some examples, fragment 604 is a 16×16 matrix, and fragment 608 is a 16×8 matrix. The 16×2 and 2×16 representations are for the purposes of illustration, only.

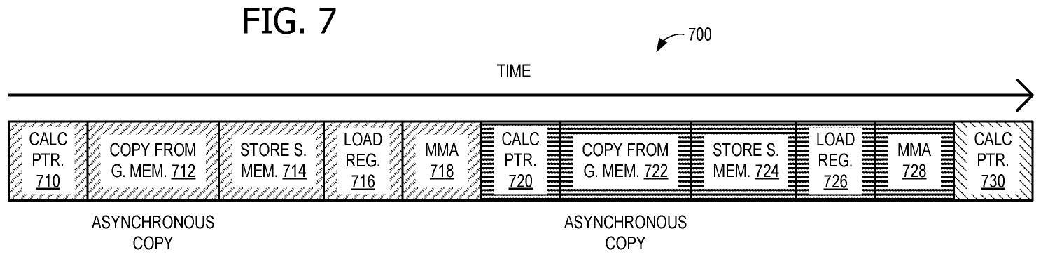

FIG. 7 illustrates a timeline 700 of events that occur in architecture 100. For thread block tile 201, the first event is pointer calculation 710, followed by copying operation 712 from global memory 108. This is followed by storing 714 data values in shared memory 130, then loading 716 data values in set of registers 106, and finally MMA calculations 718. In some examples, operations 712 and 714 are combined when using async copy. A similar sequence of events occurs for thread block tile 202. The first event is pointer calculation 720, followed by copying 722 from global memory 108. This is followed by storing 724 data values in shared memory 130, then loading 726 data values in set of registers 106, and finally MMA calculations 728. The sequence of events continues for other thread block tiles, for example, pointer calculation 730 for thread block tile 203.

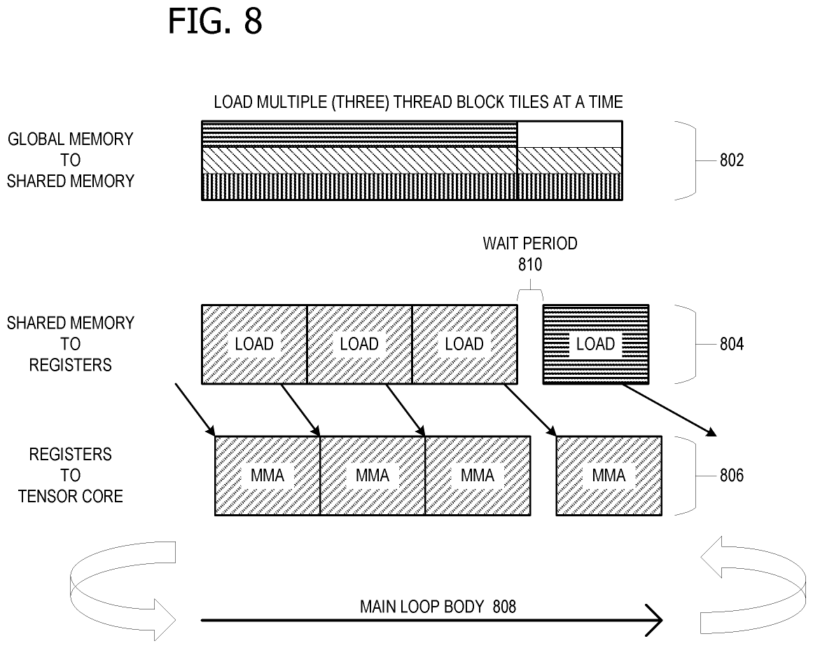

FIG. 8 illustrates data flows that occur concurrently with architecture 100. In stage 802, multiple thread block tiles are copied from global memory 108 to shared memory 130 at one time. In some examples, three thread block tiles are copied at the same time. In some examples, a different number are copied at the same time. The number of thread block tiles copied concurrently (simultaneously) may depend on the amount of available memory and the size of the matrices.

In stage 804, data values are loaded from shared memory 130 to set of registers 106. In stage 806, data values are submitted to tensor core 140 for MMA calculations. As illustrated, stages 802, 804, and 806 occur concurrently with data progressing through the stages. As shown, data values in thread block tile 201 pass from stage 802, then stage 804, then stage 806 first, followed by data values in thread block tile 202. Some data from thread block tiles 202, 203 and 204 may still be in stage 802 when data from thread block tile 201, that has already passed through stages 802 and 804, is already in stage 806.

The illustrated section is shown to be in main loop body 808, which repeats (after initial pipeline fill), until pipeline purge, when the matrix multiplication is complete. A wait period 810 is shown after data loading for thread block tile 201 have completed, while data values from thread block tile 202 are during loading. As indicated by the shading, all blocks illustrated in stage 806 are from thread block tile 201, and all blocks illustrated in stage 804 are from thread block tile 201, except the final one. The final block illustrated in stage 804 is from thread block tile 202.

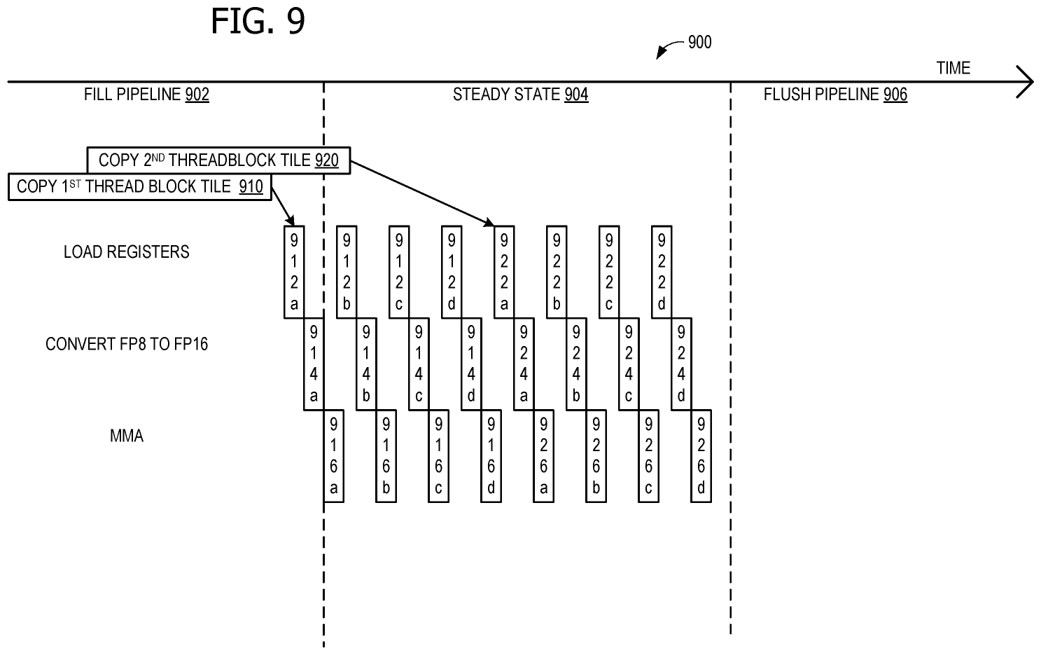

FIG. 9 illustrates a pipeline 900, implemented by architecture 100, that performs various events concurrently. FIG. 9 provides an alternative representation of the concurrency of operations in architecture 100. Three stages are shown. A fill pipeline stage 902, a steady state 904 (corresponding roughly to main loop body 808) and a flush pipeline stage 906. For simplicity, operations for only two thread block tiles are illustrated.

Operation 910 copies the first thread block tile (e.g., thread block tile 201). This is followed by four load operations for data values from the first thread block tile: load operation 912a, load operation 912b, load operation 912c, and load operation 912d. After loading, data values may be converted. Data values loaded in load operation 912a are converted in conversion operation 914a, and submitted to tensor core 140 for MMA calculations 916a.

This scheme permits different data values to be in different processes of pipeline 900 concurrently. For example, a set of data values passes through load operation 912c, a conversion operation 914c, and MMA calculations 916c. Another set of data values passes through load operation 912d, a conversion operation 914d, and MMA calculations 916d.

Operation 920 copies the second thread block tile (e.g., thread block tile 202). A set of data values from the second thread block tile passes through a load operation 922a, a conversion operation 924a, and MMA calculations 926a. Another set of data values passes through a load operation 922b, a conversion operation 924b, and MMA calculations 926b. Another set of data values passes through a load operation 922c, a conversion operation 924c, and MMA calculations 926c. Another set of data values passes through a load operation 922d, a conversion operation 924d, and MMA calculations 926d.

Steady state 904 exists from when data values are sent to tensor core 140, until no more data values are being sent to tensor core 140. In some embodiments, the FP8 to FP16 format conversion occurs simultaneously with MMA calculations 916a-d and 926a-d. In some examples, there are 7 stages of parallel operations in flight concurrently in pipeline 900.

Following steady state 904, during flush pipeline stage 906 the data values may be copied to shared memory 130 may remain in the registers with accumulation.

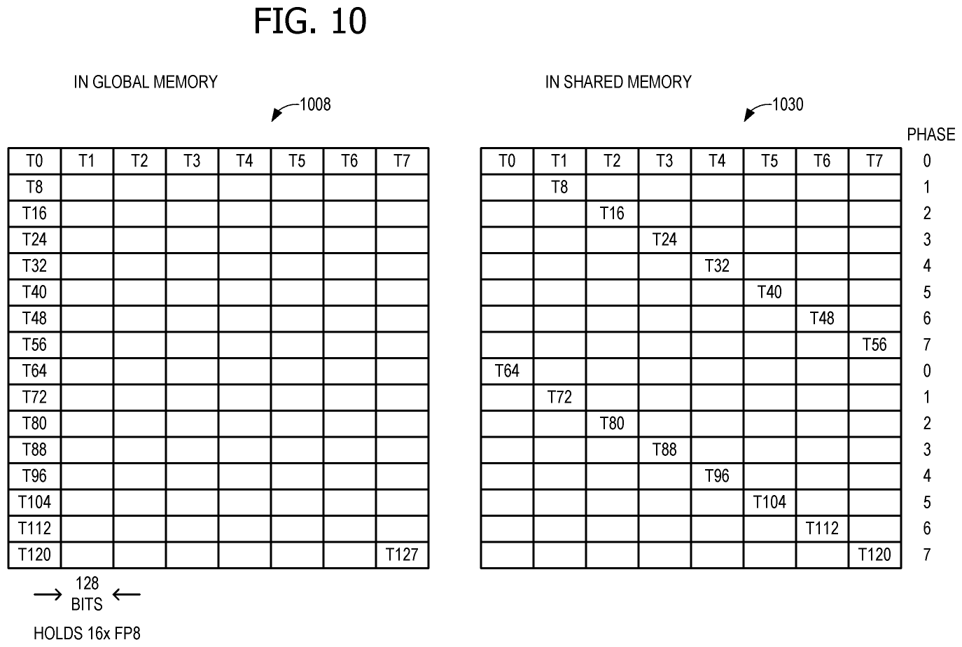

FIG. 10 provides a graphical representation of copying data values from global memory 108 to shared memory 130. Each position in memory representation grids 1008 and 1030 is 128 bits, which holds sixteen FP8 data values. Memory representation grid 1008 reflects data value positions in global memory 108. Memory representation grid 1030 reflects data value positions in shared memory 130. As can be seen, there is a shift in data value positions between memory representation grids 1008 and 1030.

One row of data values in memory representation grids 1008 and 1030 is read in each phase. A counter of the reading phases is indicated to the right side of memory representation grid 1030. When reading from or writing to global memory 108 each thread needs to handle continuous values. When reading from or writing to shared memory 130, the threads in a warp need to only read one 4-byte data from any bank in a phase.

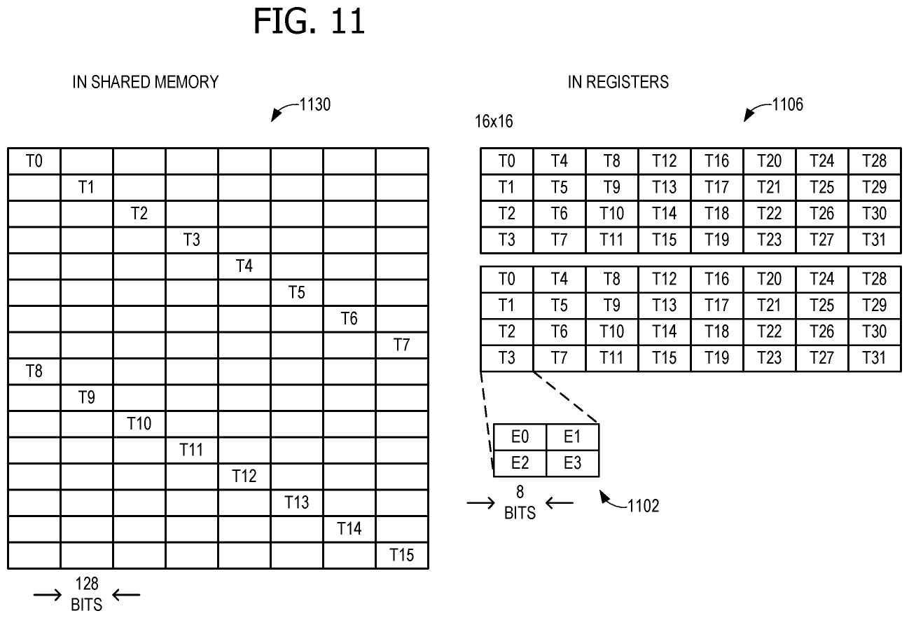

FIG. 11 provides a graphical representation of loading data values from shared memory 130 into set of registers 106. Each position in memory representation grid 1130 is 128 bits, which holds sixteen FP8 data values or eight FP16 data values. Each position in memory representation grid 1106 is 32 bits, which holds four FP8 data values or two FP16 data values. Memory representation grid 1130 reflects data value positions in shared memory 130. Memory representation grid 1106 reflects data value positions in set of registers 106. The first 16 threads in each warp load 128 bits from shared memory 130 and are distributed to 32 threads. Each thread puts eight FP8 data values in two registers. As can be seen, the data value positions differ between memory representation grids 1130 and 1106.

A register 1102 of set of registers 106 is shown holding four FP8 data values, an FP8 data value E0, an FP8 data value E1, an FP8 data value E2, and an FP8 data value E3. Because each register of set of registers 106 is 32 bits (in some examples), when data is in FP8 format, a single register stores four FP8 data values. In some examples, tensor core 140 has a layout requirement that is different than the pattern shown for memory representation grid 1106.

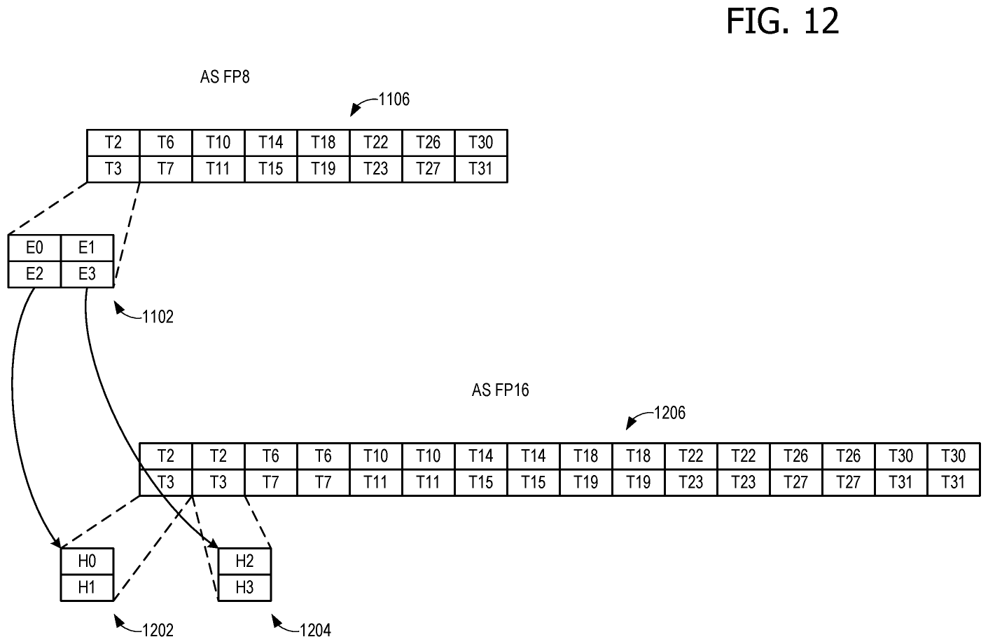

FIG. 12 provides a graphical representation of converting data values in set of registers 106 from FP8 to FP16. As in FIG. 11, memory representation grid 1106 reflects data value positions in set of registers 106, when the data values are in FP8 format. Memory representation grid 1206 reflects data value positions in set of registers 106, when the data values are in FP16 format. FP8 data value E0 is converted to FP16 data value H0; FP8 data value E2 is converted to FP16 data value H1; FP8 data value E1 is converted to FP16 data value H2; and FP8 data value E3 is converted to FP16 data value H3.

After conversion, each register contains two FP16 data values. Thirty-two bits may be occupied as either {8 bits, 8 bits, 8 bits, 8 bits} or {16 bits, 16 bits}. Register 1102 had held all four FP8 data values E0-E3. After conversion (and permutation/shifting), register 1202 holds FP16 data values H0 and H1, and register 1204 holds FP16 data values H2 and H3. In some examples, dual MMA cores compute odd and even columns of memory representation grid 1206.

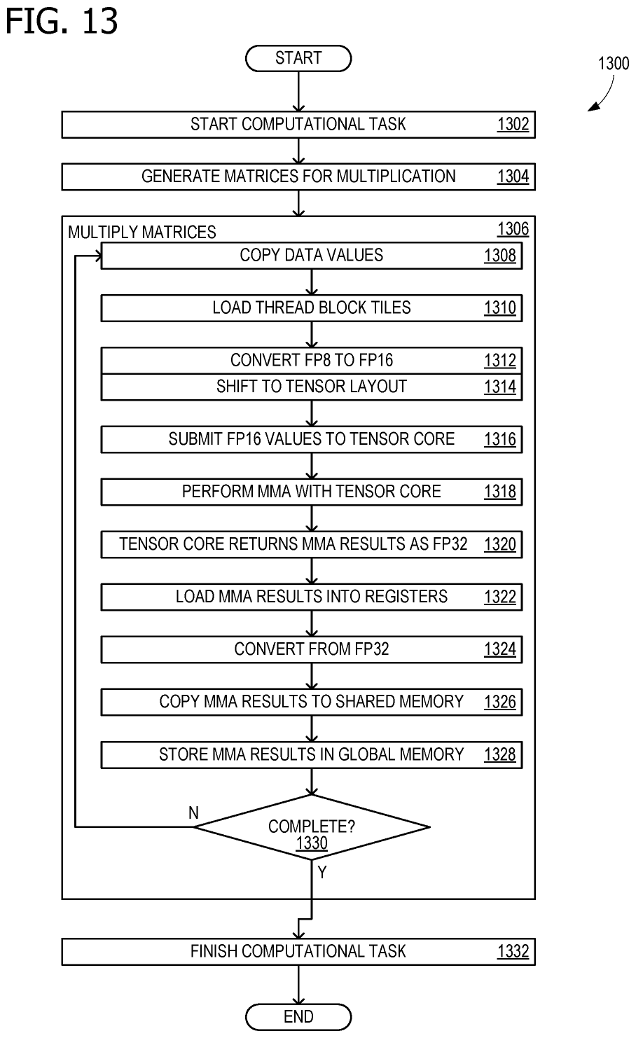

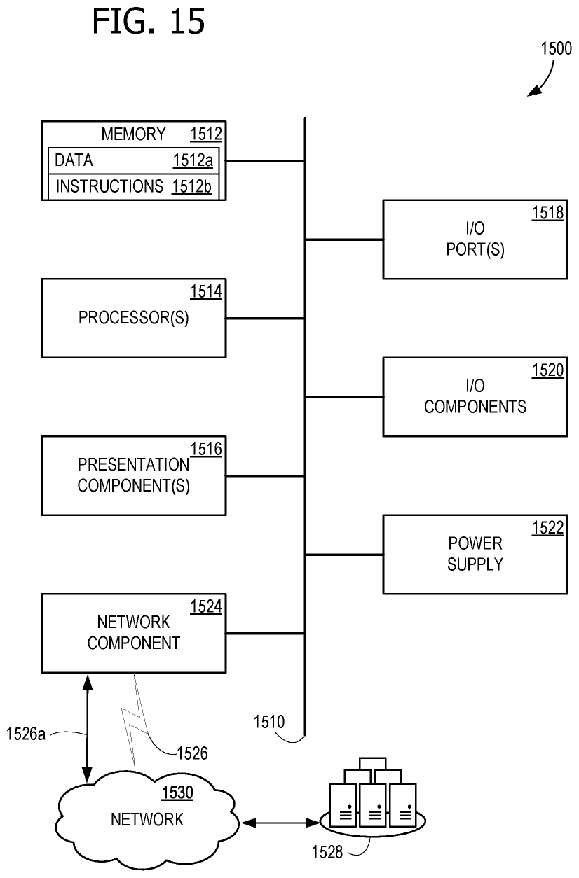

FIG. 13 shows a flowchart 1300 illustrating exemplary operations that may be performed by architecture 100. In some examples, operations described for flowchart 1300 are performed by computing device 1500 of FIG. 15. Flowchart 1300 commences with architecture 100 starting a computational project in operation 1302, which may include generating an image, generating text, generating software code, or another ML task or other project that involves matrix multiplication.

In operation 1304, architecture 100 generates matrix A 111 and matrix B 112 for multiplication in global memory 108. Operation 1306 performs matrix multiplication of matrix A 111 and matrix B, specifically MMA, to compute matrix C 113, using operations 1308-1330. Operation 1308 copies data values (e.g., data values 402a and 402b) in FP8 format from global memory 108 to shared memory 130. In some examples, copying the data values in FP8 format data from global memory 108 to shared memory 130 comprises performing an asynchronous copy operation.

Operation 1310 loads thread block tiles of FP8 data values (e.g., three thread block tiles, such as thread block tiles 201-203) from shared memory 130 into set of registers 106. In some examples, each register of set of registers 106 comprises a 32-bit register. In some examples, loading the thread block tiles of FP8 data values from shared memory 130 into set of registers 106 comprises loading four data values in the FP8 format data from shared memory 130 FP8 into a single register of set of registers 106. During steady state operations, loading the thread block tiles of FP8 data values from the shared memory 130 into set of registers 106 occurs while performing MMA computations on prior converted data values.

Operation 1312 converts each of the multiple FP8 data values in set of registers 106 to FP16 data values prior to submitting the data values to tensor core 140. Operation 1314 shifts (permutes) data positions of the FP16 data values to a layout accepted by tensor core 142, also prior to submitting the data values to tensor core 140. In some examples, operations 1312 and 1314 are performed simultaneously, so that shifting data positions of the FP16 data values to the layout accepted by tensor core 140 occurs concurrently with converting each of the multiple FP8 data values to FP16 data values.

Operation 1316 submits the FP16 data values to tensor core 140, and in operation 1318, tensor core 140 performs MMA computations using the FP16 data values. After performing the MMA computations, tensor core 140 returns MMA results 144 (e.g., the results of the MMA computations) in operation 1320. In some examples, MMA results 144 comprise FP32 data values. Operation 1322 copies MMA results 144 into set of registers 106.

Optional operation 1324 converts MMA results 144 in set of registers 106 from FP32 format to FP16 format or FP8 format. Operation 1326 copies MMA results 144 from set of registers 106 into shared memory 130. Operation 1328 stores MMA results 144 to global memory 108. Decision operation 1330 determines whether the matrix multiplication of operation 1306 is complete. If not, flowchart 1300 returns to operation 1308 to continuing to copy data values from global memory 108 to the shared memory 130, load data values into set of registers 106, convert data value format, and submit data values to the tensor core, until MMA computations for matrices in global memory 108 are complete.

Otherwise, operation 1332 finishes computational task 110 to generate an output (output product 150), for example by generating an image, generating text, or generating software code using the MMA computations.

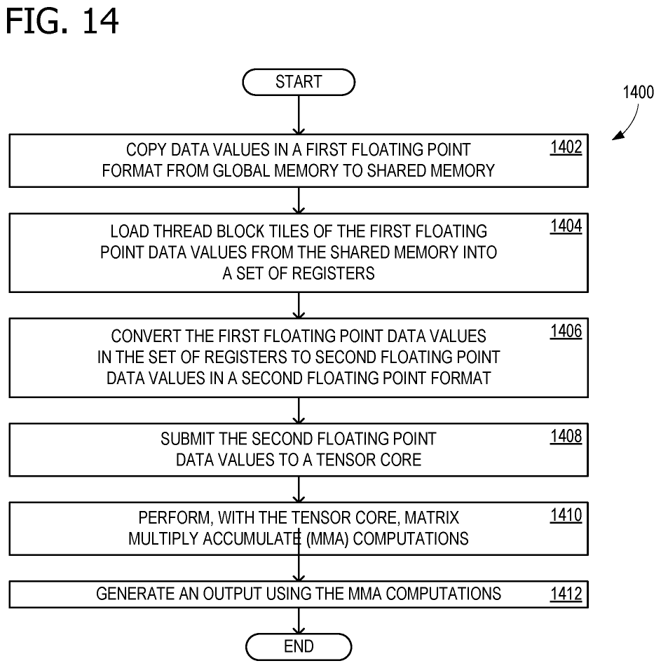

FIG. 14 shows a flowchart 1400 illustrating exemplary operations that may be performed by architecture 100. In some examples, operations described for flowchart 1400 are performed by computing device 1500 of FIG. 15. Flowchart 1400 commences with operation 1402, which includes copying data values in a first floating point format from global memory to shared memory.

Operation 1404 includes loading thread block tiles of the first floating point data values from the shared memory into a set of registers. Operation 1406 includes converting the first floating point data values in the set of registers to second floating point data values in a second floating point format. Operation 1408 includes submitting the second floating point data values to a tensor core. Operation 1410 includes performing, with the tensor core, MMA computations. Operation 1412 includes generating an output using the MMA computations.

### ADDITIONAL EXAMPLES

An example system comprises: a processor; and a computer-readable medium storing instructions that are operative upon execution by the processor to: copy data values in a first floating point format from global memory to shared memory; load thread block tiles of the first floating point data values from the shared memory into a set of registers; convert the first floating point data values in the set of registers to second floating point data values in a second floating point format; submit the second floating point data values to a tensor core; perform, with the tensor core, MMA computations; and generate an output using the MMA computations.

An example method comprises: asynchronously copying data values in a first floating point format from global memory to shared memory; loading thread block tiles of the first floating point data values from the shared memory into a set of registers; converting the first floating point data values in the set of registers to second floating point data values in a second floating point format; submitting the second floating point data values to a tensor core; performing, with the tensor core, MMA computations; and generating an output using the MMA computations.

One or more example computer storage devices has computer-executable instructions stored thereon, which, on execution by a computer, cause the computer to perform operations comprising: copying data values in a first floating point format from global memory to shared memory; loading thread block tiles of the first floating point data values from the shared memory into a set of registers while performing matrix multiply accumulate (MMA) computations on prior converted data values; converting the first floating point data values in the set of registers to second floating point data values in a second floating point format; submitting the second floating point data values to a tensor core; performing, with the tensor core, MMA computations; and generating an output using the MMA computations.

Alternatively, or in addition to the other examples described herein, examples include any combination of the following:
the first floating point format comprises FP8;
the second floating point format comprises FP16;
copying the data values in the first floating point format from the global memory to the shared memory comprises performing an asynchronous copy operation;
the global memory comprises HBM;
the global memory comprises HBM2;
each register of the set of registers comprises a 32-bit register;
loading the thread block tiles of the first floating point format data values from the shared memory into the set of registers comprises loading four data values in the first floating point format from the shared memory into a single register of the set of registers;
loading the thread block tiles of the first floating point format data values from the shared memory into the set of registers while performing MMA computations on prior converted data values;
prior to submitting data values to the tensor core, shifting data positions of the second floating point format data values to a layout accepted by the tensor core;
shifting data positions of the second floating point format data values to the layout accepted by the tensor core concurrently with converting each of the first floating point format data values to the second floating point format data values;
the tensor core is within a GPU;
performing the MMA computations using the second floating point format data values;
after performing the MMA computations, returning, by the tensor core, MMA results of the MMA computations;
the MMA results comprise FP32 data values;
loading the MMA results into the set of registers;
converting the MMA results in the set of registers to second floating point format data values;
converting the MMA results in the set of registers to first floating point format data values;
copying the MMA results to the shared memory;
storing the MMA results to the global memory;
continuing to copy data values from the global memory to the shared memory, load data values into the set of registers, convert data value format, and submit data values to the tensor core, until MMA computations for matrices in the global memory are complete;
generating an image using the MMA computations;
generating text using the MMA computations; and
generating software code using the MMA computations.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 15 is a block diagram of an example computing device 1500 (e.g., a computer storage device) for implementing aspects disclosed herein, and is designated generally as computing device 1500. In some examples, one or more computing devices 1500 are provided for an on-premises computing solution. In some examples, one or more computing devices 1500 are provided as a cloud computing solution. In some examples, a combination of on-premises and cloud computing solutions are used. Computing device 1500 is but one example of a suitable computing environment and is not intended to suggest any limitation as to the scope of use or functionality of the examples disclosed herein, whether used singly or as part of a larger set.

Neither should computing device 1500 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 1500 includes a bus 1510 that directly or indirectly couples the following devices: computer storage memory 1512, one or more processors 1514, one or more presentation components 1516, input/output (I/O) ports 1518, I/O components 1520, a power supply 1522, and a network component 1524. While computing device 1500 is depicted as a seemingly single device, multiple computing devices 1500 may work together and share the depicted device resources. For example, memory 1512 may be distributed across multiple devices, and processor(s) 1514 may be housed with different devices.

Bus 1510 represents what may be one or more busses (such as an address bus, data bus, or a combination thereof). Although the various blocks of FIG. 15 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 15 and the references herein to a “computing device.” Memory 1512 may take the form of the computer storage media referenced below and operatively provide storage of computer-readable instructions, data structures, program modules and other data for the computing device 1500. In some examples, memory 1512 stores one or more of an operating system, a universal application platform, or other program modules and program data. Memory 1512 is thus able to store and access data 1512a and instructions 1512b that are executable by processor 1514 and configured to carry out the various operations disclosed herein.

In some examples, memory 1512 includes computer storage media. Memory 1512 may include any quantity of memory associated with or accessible by the computing device 1500. Memory 1512 may be internal to the computing device 1500 (as shown in FIG. 15), external to the computing device 1500 (not shown), or both (not shown). Additionally, or alternatively, the memory 1512 may be distributed across multiple computing devices 1500, for example, in a virtualized environment in which instruction processing is carried out on multiple computing devices 1500. For the purposes of this disclosure, “computer storage media,” “computer-storage memory,” “memory,” and “memory devices” are synonymous terms for the computer-storage memory 1512, and none of these terms include carrier waves or propagating signaling.

Processor(s) 1514 may include any quantity of processing units that read data from various entities, such as memory 1512 or I/O components 1520. Specifically, processor(s) 1514 are programmed to execute computer-executable instructions for implementing aspects of the disclosure. The instructions may be performed by the processor, by multiple processors within the computing device 1500, or by a processor external to the client computing device 1500. In some examples, the processor(s) 1514 are programmed to execute instructions such as those illustrated in the flow charts discussed below and depicted in the accompanying drawings. Moreover, in some examples, the processor(s) 1514 represent an implementation of analog techniques to perform the operations described herein. For example, the operations may be performed by an analog client computing device 1500 and/or a digital client computing device 1500. Presentation component(s) 1516 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 1500, across a wired connection, or in other ways. I/O ports 1518 allow computing device 1500 to be logically coupled to other devices including I/O components 1520, some of which may be built in. Example I/O components 1520 include, for example but without limitation, a microphone, joystick, game pad, satellite dish, scanner, printer, wireless device, etc.

Computing device 1500 may operate in a networked environment via the network component 1524 using logical connections to one or more remote computers. In some examples, the network component 1524 includes a network interface card and/or computer-executable instructions (e.g., a driver) for operating the network interface card. Communication between the computing device 1500 and other devices may occur using any protocol or mechanism over any wired or wireless connection. In some examples, network component 1524 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1524 communicates over wireless communication link 1526 and/or a wired communication link 1526a to a remote resource 1528 (e.g., a cloud resource) across network 1530. Various different examples of communication links 1526 and 1526a include a wireless connection, a wired connection, and/or a dedicated link, and in some examples, at least a portion is routed through the internet.

Although described in connection with an example computing device 1500, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
copy data values in a first floating point format from global memory to shared memory;
load thread block tiles of the first floating point data values from the shared memory into a set of registers;
convert the first floating point data values in the set of registers to second floating point data values in a second floating point format;
submit the second floating point data values to a tensor core;
perform, with the tensor core, matrix multiply accumulate (MMA) computations; and
generate a recommendation using the MMA computations.

2. The system of claim 1,
wherein the first floating point format comprises 8-bit floating point (FP8) format;
wherein the second floating point format comprises 16-bit floating point (FP16) format; and
wherein results of the MMA computations comprise 16-bit FP16 data values or 32-bit floating point (FP32) data values.

3. The system of claim 1, wherein loading the thread block tiles of the first floating point data values from the shared memory into the set of registers comprises loading four data values in the first floating point format from the shared memory into a single register of the set of registers.

4. The system of claim 3, wherein the instructions are further operative to:
load the thread block tiles of the first floating point data values from the shared memory into the set of registers while performing MMA computations on prior converted data values.

5. The system of claim 1, wherein the instructions are further operative to:
prior to submitting data values to the tensor core, shift data positions of the second floating point data values to a layout accepted by the tensor core concurrently with converting the first floating point data values to the second floating point data values.

6. The system of claim 1, wherein the instructions are further operative to:
continue to copy data values from the global memory to the shared memory, load data values into the set of registers, convert data value format, and submit data values to the tensor core, until MMA computations for matrices in the global memory are complete.

7. The system of claim 1, wherein generating the recommendation comprises:
generating an image using the MMA computations;
generating text using the MMA computations; or
generating software code using the MMA computations.

8. A method comprising:
asynchronously copying data values in a first floating point format from global memory to shared memory;
loading thread block tiles of the first floating point data values from the shared memory into a set of registers;
converting the first floating point data values in the set of registers to second floating point data values in a second floating point format;
submitting the second floating point data values to a tensor core;
performing, with the tensor core, matrix multiply accumulate (MMA) computations; and
generating an output using the MMA computations.

9. The method of claim 8,
wherein the first floating point format comprises 8-bit floating point (FP8) format;
wherein the second floating point format comprises 16-bit floating point (FP16) format; and
wherein results of the MMA computations comprise 16-bit FP16 data values or 32-bit floating point (FP32) data values.

10. The method of claim 8, wherein loading the thread block tiles of the first floating point data values from the shared memory into the set of registers comprises loading four data values in the first floating point format from the shared memory into a single register of the set of registers.

11. The method of claim 10, further comprising:
loading the thread block tiles of the first floating point data values from the shared memory into the set of registers while performing MMA computations on prior converted data values.

12. The method of claim 8, further comprising:
prior to submitting data values to the tensor core, shifting data positions of the second floating point data values to a layout accepted by the tensor core concurrently with converting the first floating point data values to the second floating point data values.

13. The method of claim 8, further comprising:
continuing to copy data values from the global memory to the shared memory, load data values into the set of registers, convert data value format, and submit data values to the tensor core, until MMA computations for matrices in the global memory are complete.

14. The method of claim 8, wherein generating the output comprises:
generating an image using the MMA computations;
generating text using the MMA computations; or
generating software code using the MMA computations.

15. One or more computer storage devices having computer-executable instructions stored thereon, which, on execution by a computer, cause the computer to perform operations comprising:
copying data values in a first floating point format from global memory to shared memory;
loading thread block tiles of the first floating point data values from the shared memory into a set of registers while performing matrix multiply accumulate (MMA) computations on prior converted data values;
converting the first floating point data values in the set of registers to second floating point data values in a second floating point format;
submitting the second floating point data values to a tensor core;
performing, with the tensor core, MMA computations; and
generating an output using the MMA computations.

16. The one or more computer storage devices of claim 15,
wherein the first floating point format comprises 8-bit floating point (FP8) format;
wherein the second floating point format comprises 16-bit floating point (FP16) format; and
wherein results of the MMA computations comprise 16-bit FP16 data values or 32-bit floating point (FP32) data values.

17. The one or more computer storage devices of claim 15, wherein loading the thread block tiles of the first floating point data values from the shared memory into the set of registers comprises loading four data values in the first floating point format from the shared memory into a single register of the set of registers.

18. The one or more computer storage devices of claim 15, wherein the operations further comprise:
prior to submitting data values to the tensor core, shifting data positions of the second floating point data values to a layout accepted by the tensor core concurrently with converting the first floating point data values to the second floating point data values.

19. The one or more computer storage devices of claim 15, wherein the operations further comprise:
continuing to copy data values from the global memory to the shared memory, load data values into the set of registers, convert data value format, and submit data values to the tensor core, until MMA computations for matrices in the global memory are complete.

20. The one or more computer storage devices of claim 15, wherein generating the output comprises:
generating an image using the MMA computations;
generating text using the MMA computations; or
generating software code using the MMA computations.
